(19) United States
(12) Patent Application Publication
(10) Pub. No.: US 2015/0167917 A1
(43) Pub. Date: Jun. 18, 2015

(54) VEHICLE LAMP HAVING REFLECTIVE FILM

(71) Applicant: Koito Manufacturing Co., Ltd., Tokyo (JP)

(72) Inventors: Haruhito Takahashi, Shizuoka-shi (JP); Shigehiko Kazaoka, Shizuoka-shi (JP); Katsuhisa Shinji, Shizuoka-shi (JP); Tomomi Ishikawa, Shizuoka-shi (JP)

(73) Assignee: Koito Manufacturing Co., Ltd., Tokyo (JP)

(21) Appl. No.: 14/104,187

(22) Filed: Dec. 12, 2013

(30) Foreign Application Priority Data
Dec. 12, 2013 (JP) 2012271882

(51) Int. Cl. F21S 8/10

(52) U.S. Cl. CPC F21S 48/20; F21S 48/22

(57) ABSTRACT

A vehicle lamp includes a lamp body, an outer cover covering a front surface of the lamp body such that a lamp chamber is formed between the lamp body and the outer cover, a light source disposed inside the lamp chamber, an inner lens disposed inside the lamp chamber to guide light emitted by the light source such that the light is sent to an outside of the lamp chamber from the outer cover, and a reflective film provided on at least one of the outer cover and the inner lens to reflect external light from the outside of the lamp chamber. A portion of the reflective film is formed with a light transmitting portion through which the light from the light source is transmitted to the outside of the lamp chamber.

### CROSS-REFERENCE TO RELATED APPLICATION(S)

The present application claims the benefit of priority of Japanese Patent Application No. 2012-271882, filed on Dec. 13, 2012, the content of which is incorporated herein by reference.

### TECHNICAL FIELD

The present disclosure relates to a vehicle lamp having a reflective film to conceal components inside a lamp chamber from the outside of the lamp while the lamp is turned off.

### BACKGROUND

Related art lamps have a reflective film provided on an outer lens or on an inner lens. For example, a related art side turn signal lamp to be mounted on a door minor has an outer lens that is half-mirrored by vapor deposition, sputtering or the like such that a reflective film having a light transmission rate of 20% to 80% is formed, so as to provide a mirror-like outer appearance while the lamp is turned off and to conceal the components inside the lamp chamber (see, e.g., JP4239839B2). According to another related art, the reflective film may be partially removed by laser beam to form a decorative pattern on an extension or on a lens of a lamp (see, e.g., JP2010-192217A).

However, the related art half-minor treatment is likely to produce a reflective film with non-uniform thickness that makes the light transmission rate different at each location on a light emitting surface, which would result in an uneven light emission while the lamp is turned on. That is, defective products are likely to be produced, which raises production cost. While the lamp is turned off, on the other hand, the interior of the lamp becomes unobservable by the reflection on the entire surface of the light emitting region. However, the outer appearance is planar and monotonous so that impact of design is limited.

### SUMMARY

The present disclosure provides a vehicle lamp having an improved design on an outer appearance and can be manufactured at low cost with easy control of reflective film thickness.

According to an aspect of the present disclosure, a vehicle lamp includes a lamp body, an outer cover covering a front surface of the lamp body such that a lamp chamber is formed between the lamp body and the outer cover, a light source disposed inside the lamp chamber, an inner lens disposed inside the lamp chamber to guide light emitted by the light source such that the light is sent to an outside of the lamp chamber from the outer cover, and a reflective film provided on at least one of the outer cover and the inner lens to reflect external light from the outside of the lamp chamber. A portion of the reflective film is formed with a light transmitting portion through which the light from the light source is transmitted to the outside of the lamp chamber.

Other aspects, features and advantages will be apparent from the following description, the drawings and the claims.

### BRIEF DESCRIPTION OF THE DRAWINGS

FIG. 1 is a diagram illustrating an outer appearance of a side turn signal lamp according to an implementation of the present invention;

FIG. 2 is a sectional view of the side turn signal lamp, taken along the line II-II in FIG. 1;

FIG. 3 is a horizontal sectional view of the side turn signal lamp;

FIG. 4A is a front view of the side turn signal lamp that is being turned off;

FIG. 4B is a front view of the side turn signal lamp that is being turned on;

FIG. 5A is a front view of a portion of an outer cover according to a modified example, with the light being turned off;

FIG. 5B is a front view of the portion of the outer cover of FIG. 5A with the light being turned on;

FIG. 5C is a front view of a portion of an outer cover according to another modified example having a higher dot density than the outer cover of FIG. 5A, with the light being turned off;

FIG. 5D is a front view of the portion of the outer cover of FIG. 5C with the light being turned on, providing brighter light than the portion of the outer cover of FIG. 5B;

FIG. 6A is a front view of a portion of an outer cover having a different light emitting pattern, with the light being turned off;

FIG. 6B is a front view of the portion of the outer cover of FIG. 6A with the light being turned on;

FIG. 6C is a front view of a portion of an outer cover another different light emitting pattern, with the light being turned off;

FIG. 6D is a front view of the portion of the outer cover of FIG. 6C with the light being turned on;

FIG. 7 is a horizontal sectional view of a side turn signal lamp having an inner lens of a different shape; and

FIG. 8 is a horizontal sectional view of a side turn signal lamp having an inner lens of another different shape.

### DETAILED DESCRIPTION

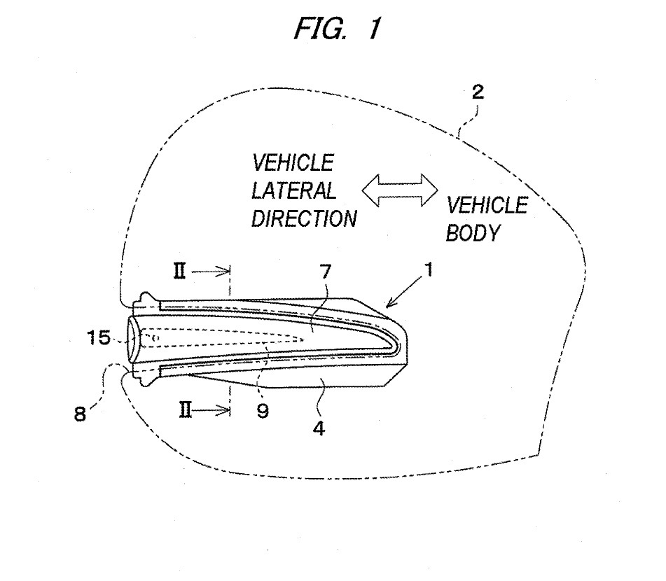

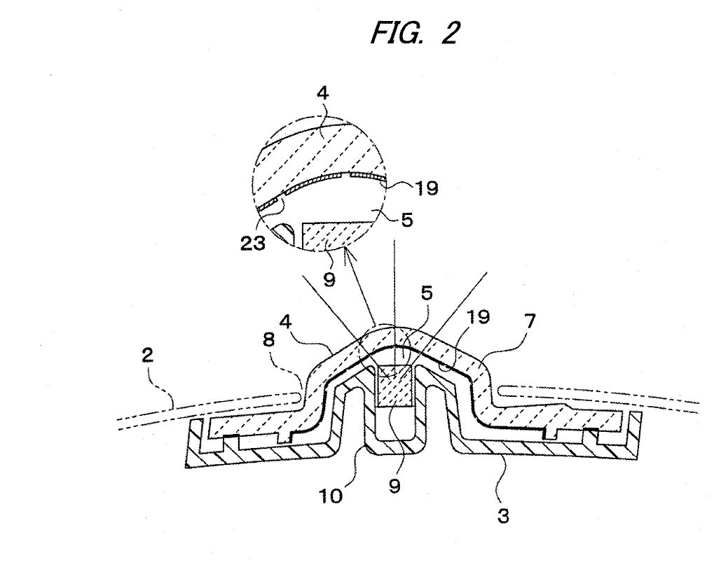

Hereinafter, an implementation of the invention will be described below with reference to the drawings. As shown in FIGS. 1 and 2, a side turn signal lamp 1 has a lamp body 3 to be incorporated in a door mirror 2. An outer cover 4 is arranged to cover a front surface of the lamp body 3, so that a lamp chamber 5 is formed between the outer cover 4 and the lamp body 3. The outer cover 4 has a laterally elongated molding portion 7 arranged to be exposed through an opening portion 8 of the door minor 2. An inner lens 9 is arranged on an inner side of the molding portion 7, and is held in position by a holding portion 10 of the lamp body 3.

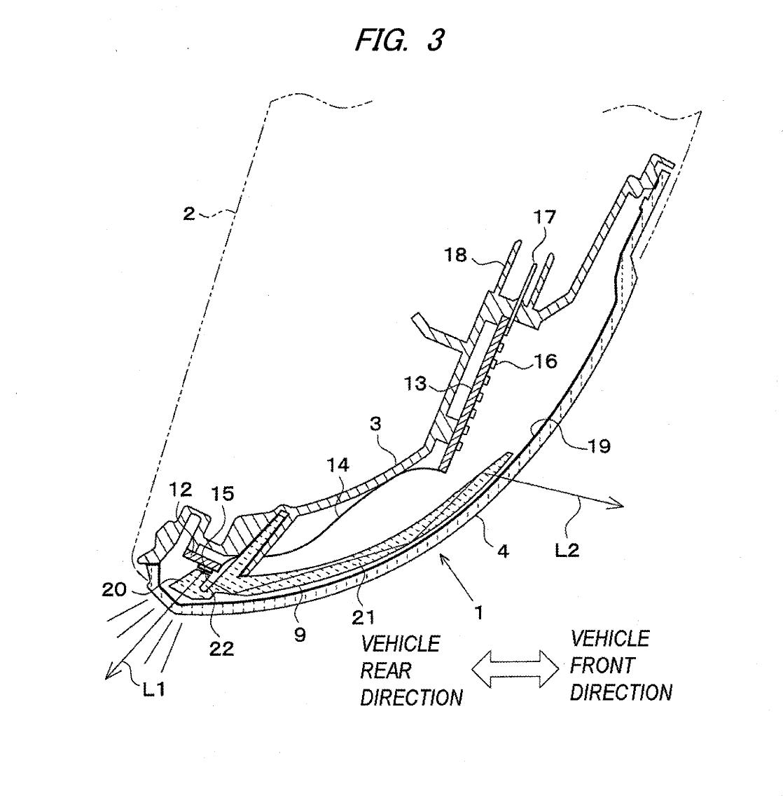

As shown in FIGS. 2 and 3, a light source board 12 and a power source board 13 are arranged on the lamp body 3 so as to be separated from each other in a front-rear direction of the vehicle, and are coupled to each other via an electric wiring 14. A light emitting diode (LED) light source 15 is mounted on the light source board 12 such that the LED light source 15 faces rearward at one end portion in the lamp chamber 5. Circuit devices 16 and connector pins 17 are provided on the power source board 13. A socket 18 is provided to protrude from an outer surface of the lamp body 3. The side turn signal lamp 1 is configured such that the light from the LED light source 15 is guided by the inner lens 9 and is sent to the outside of the lamp chamber 5 through the outer cover 4.

The inner lens 9 is made of a light transmissive resin material, and is formed in a strip extending in the front-rear direction of the vehicle. The inner lens 9 has a light irradiating portion 20 from which an irradiation light L1 is sent out toward the rear of the vehicle, a decorative portion 21 from which a decorative light L2 is sent out toward the front of the vehicle, and a slit 22 separating the light irradiating portion 20 and the decorative portion 21. The light irradiating portion 20 receives direct light from the LED light source 15, and irradiates the light in a brighter manner than the decorative portion 21. The decorative portion 21 receives light that has passed across the slit 22, and guides the light toward the front of the vehicle. A reflective film 19 is formed on an inner surface of the outer cover 4 to cover the inner lens 9 over the entire length of the inner lens 9, such that the components inside the lamp chamber, such as the boards 12, 13, the electric wiring 14, and the light source 15, are covered and concealed from the front view of the lamp.

As shown in FIG. 2, the reflective film 19 is formed on the inner surface of a portion of the outer cover 4 including the molding portion 7 exposed through the door mirror 2, by aluminum vapor deposition or sputtering. A portion of the reflective film 19 is formed with lines of light transmitting portions extending substantially parallel to each other and along the longitudinal direction of the molding portion 7. The light that has been guided by the inner lens 9 from the LED light source 15 is sent to the outside of the lamp chamber 5 through the light transmitting portions 23. The light transmitting portions 23 are formed in fine lines of about 0.1 mm or narrower by removing the corresponding portions of the reflective film 19 by laser beam. Alternatively, the light transmitting portions 23 may be formed, for example, by cutting a portion of the reflective film 19 or by forming the reflective film 19 with the corresponding portions being masked.

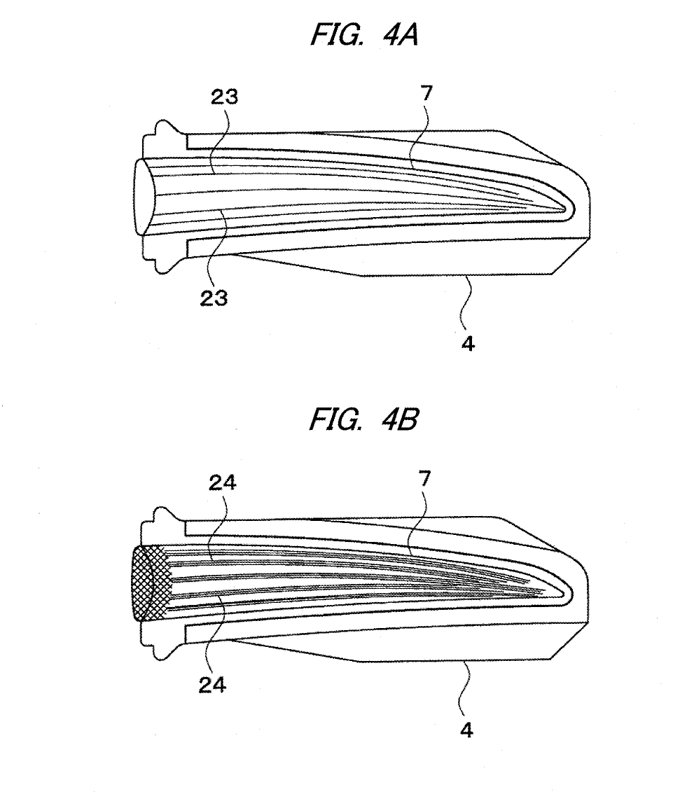

By forming the light transmitting portions 20 in fine and narrow lines, when the LED light source 15 is turned off, as shown in the FIG. 4A, the light transmitting portions 23 cannot be observed from the front view of the lamp (FIG. 4A shows the light transmitting portions 23 are for the purpose of illustration), and the entire surface of the molding portion 7 looks like a shiny plated molding. When the LED light source is turned on, as shown in FIG. 4B, the light transmitting through the light transmitting portions 23 forms a plurality of light emitting lines that are thicker than the light transmitting portions 23 on the molding portion 7. Accordingly, it is not necessary to adjust the light transmitting rate of the reflective film 19, and the reflective film 19 can be formed with normal accuracy. Thus, defective products are reduced, and the outer cover 4 can be manufactured at lower cost.

Further, according to the side turn signal lamp 1, the light irradiating portion 20 is provided at the rear end of the elongated inner lens 9, and the light emitting lines 24 are formed to extend from the rear end of the outer cover 4 toward the decorative portion 21 on the front side. That is, the irradiation light L1 sent out from the light irradiating portion 20 brightly irradiates the rearward region, while the decorative light L2 (the light emitting lines 23) sent out from the light transmitting portions 23 at the decorative portion 21 improves the outer appearance of the lamp in the front view. Specifically, the molding portion 7 has a raised shape, and the light emitting lines 24 are formed on this raised molding portion 7, giving a three-dimensional appearance and bright-dark contrast on the front side design of the lamp, whereby the design of the side turn signal lamp 1 is improved.

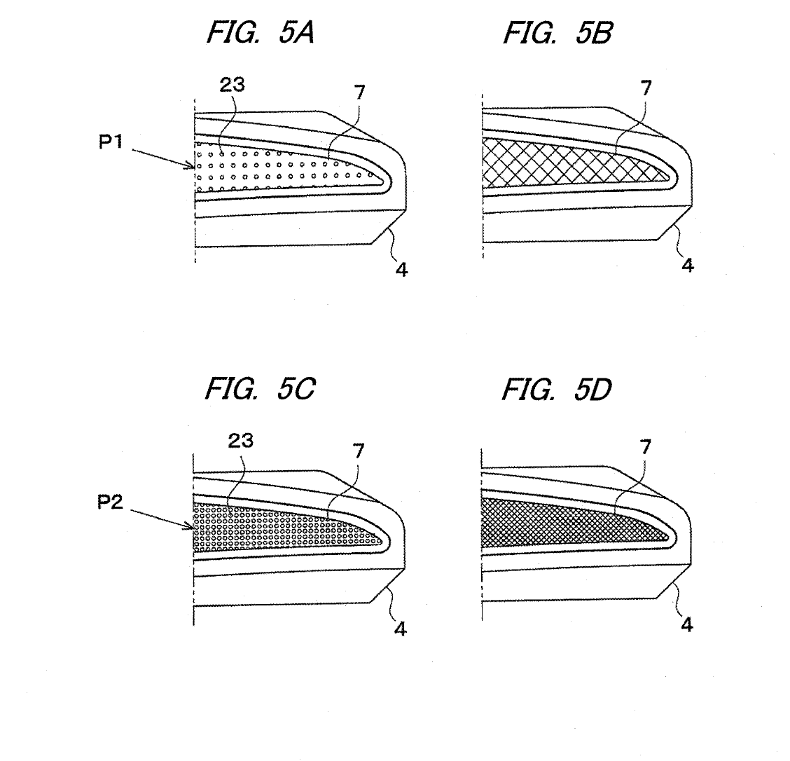

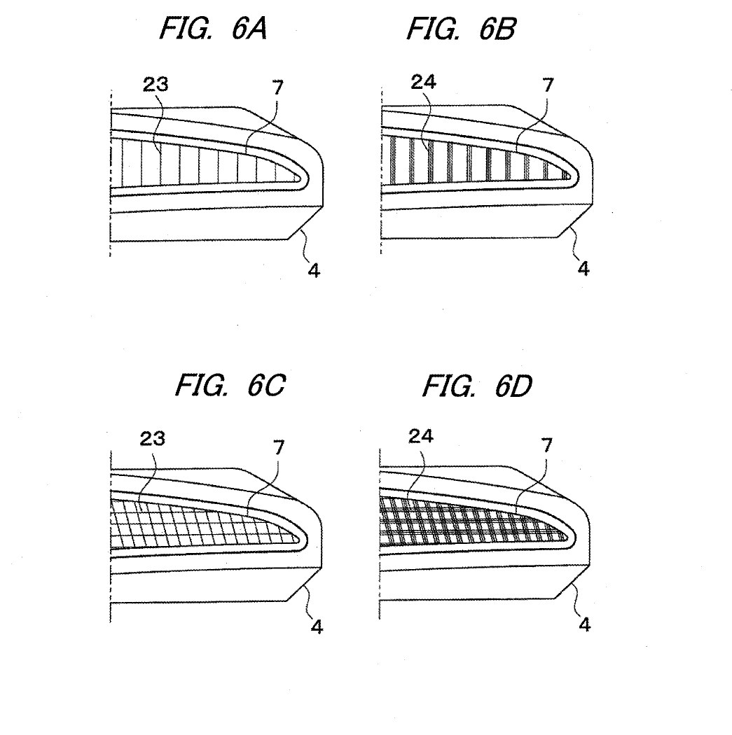

FIGS. 5A to 6D illustrate modified examples of the light transmitting portions 23. The light transmitting portions 23 shown in FIGS. 5A and 5C are formed by removing the reflective film 19 in a dotted manner by laser beam to form dot matrix pattern P1, P2 on the molding portion 7 of the outer cover 4 such that the light transmitting rate of the reflective film 19 is set by the dot density. For example, by lowering the dot density like the pattern P1 shown in FIG. 5A, the light transmitting rate of the reflective film at the time when the lamp is turned on can be lowered, so that the molding portion 7 emits light in a darker manner (see FIG. 5B). By increasing the dot density like the pattern P2 shown in FIG. 5C, the light transmitting rate of the reflective film is increased, so that the molding portion 7 emits light in a brighter manner (see FIG. 5D).

The light transmitting portions 23 shown in FIG. 6A are formed by removing the reflective film in fine and narrow vertical lines by laser beam, so that when the LED light source 15 is turned on, vertical light emitting lines 24 are formed on the molding portion 7 (see FIG. 6B). The light transmitting portions 23 shown in Fog. 6C are formed by removing the reflective film in fine and narrow grid lines, so that when the LED light source 15 is turned on, light emitting lines 24 of a grid pattern is formed on he molding portion 7 (see FIG. 6D). The patterns of the light transmitting portions 23 and the light emitting lines 24 are not limited to those described above, and can be changed depending on the location of the lamp on the vehicle and the use of the vehicle lamp.

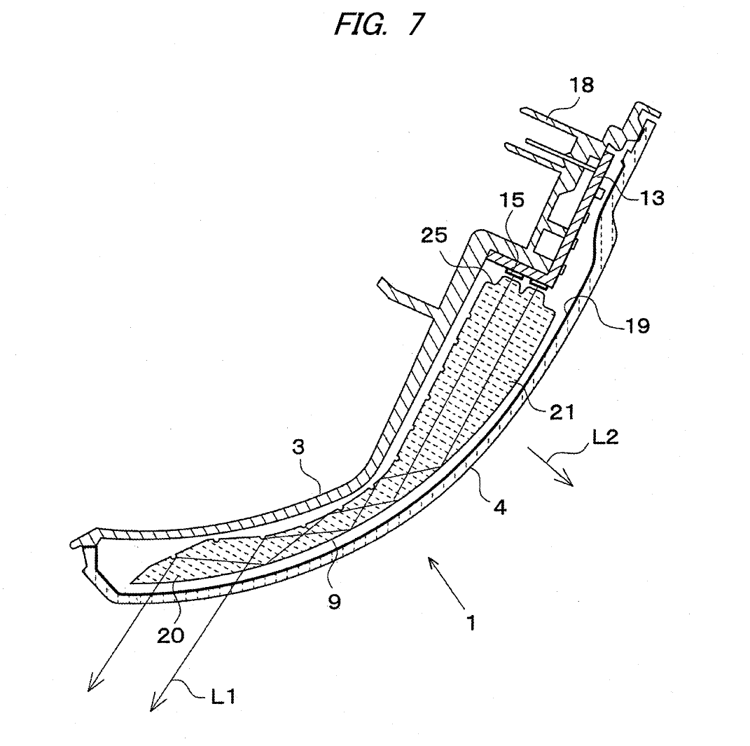

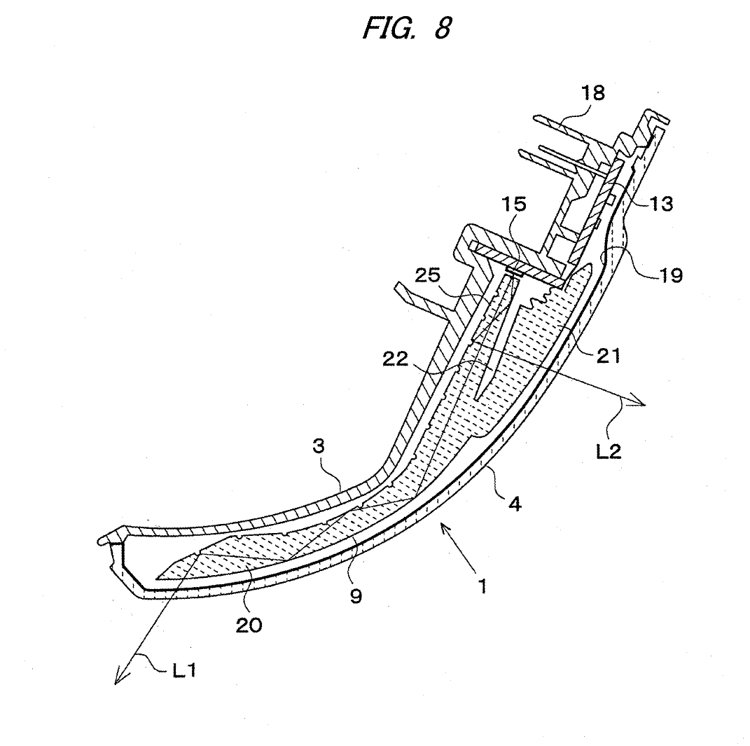

FIGS. 7 and 8 illustrate modified examples of the inner lens 9. According to the side turn signal lamp 1 shown in FIG. 7, the board 13 and the socket 18 are provided on the lateral end portion of the lamp body 3 on the side of the vehicle body, and a plurality of LED light sources 15 are provided on the board 13. The inner lens 9 receives light of the LED light sources 15 from a light entering portion 25 at a front portion of the inner lens 9. A part o the light is sent out as the decorative light L2 from the decorative portion 21, and the other part of the light is collected at the rear end and is sent out as the irradiation light L1 from the light irradiating portion 20. According to the side turn signal lamp 1 shown in FIG. 8, the inner lens 9 is partially divided in front and rear by the slit 22. The light entering portion 25 is formed on the rear side of the slit 22, and the decorative portion 21 is provided on the front side of the slit 22.

The subject matter of the present disclosure is not limited to the side turn signal lamp 1, and is applicable to other vehicle lamps, such as a clearance lamp, a daytime running lamp, a rear combination lamp and the like. In other implementations, moreover, the reflective film 19 may be provided on a front surface of the inner lens 9, and/or may be provided on both the outer cover 4 and the inner lens 9.

The subject matter of the present disclosure is not limited to the implementation described in detail above. Various changes and modifications can be made therein without departing from the scope defined by the appended claims.

1. A vehicle lamp comprising:
a lamp body;
an outer cover covering a front surface of the lamp body such that a lamp chamber is formed between the lamp body and the outer cover;
a light source disposed inside the lamp chamber;
an inner lens disposed inside the lamp chamber to guide light emitted by the light source such that the light is sent to an outside of the lamp chamber from the outer cover; and
a reflective film to reflect external light from outside of the lamp chamber,.
wherein the outer cover comprises a molding portion extending along the inner lens,
the reflective film is on an inner surface of a portion of the outer cover including the molding portion, and
a portion of the reflective film is formed with a light transmitting portion through which the light from the light source is transmitted to the outside of the lamp chamber.

2. The vehicle lamp according to claim 1, wherein the inner lens has a strip shape.

3. The vehicle lamp according to claim 2, wherein the inner lens comprises:
a decorative portion at one of the inner lens to send out a part of the light from the light source as a decorative light; and
a light irradiating portion at the other end of the inner lens to emit another part of light in a brighter manner than the decorative portion.

4. The vehicle lamp according to claim 3, wherein the reflective film is formed on the outer cover to cover the inner lens along an entire length of the inner lens.

5. (canceled)

6. The vehicle lamp according to claim 1, wherein the light transmitting portion is formed by removing a portion of the reflective film by laser beam.

7. The vehicle lamp according to claim 4, wherein the light transmitting portion forms a dot matrix pattern on the reflective film, and a light transmitting rate of the reflective film is set by a dot density of the dot matrix pattern.

8. The vehicle lamp according to claim 1, wherein the light transmitting portion comprises lines or dots.

9. The vehicle lamp according to claim 8, wherein the light transmitting portion comprises lines each of which is 0.1 mm or narrower.

10. The vehicle lamp according to claim 8, wherein the light transmitting portion comprises dots arranged to form a dot matrix pattern.

11. The vehicle lamp according to claim 1 wherein the lamp body is incorporated into a vehicle door mirror having an opening, wherein the molding portion of the outer cover of the vehicle lamp protrudes through the opening, and wherein the reflective film is on an inner surface of the molding portion including an area that protrudes through the opening.
